(19) United States
(12) Patent Application Publication
(10) Pub. No.: US 2015/0305128 A1
(43) Pub. Date: Oct. 22, 2015

(54) PROTECTING CIRCUIT FOR ARC DISCHARGE LAMP

(71) Applicant: GENERAL ELECTRIC COMPANY, Schenectady, NY (US)

(72) Inventors: Hongbin Wei, ShangHai (CN); Youmin Zhang, ShangHai (CN)

(73) Assignee: GENERAL ELECTRIC COMPANY, Schenectady, NY (US)

(21) Appl. No.: 14/254,312

(22) Filed: Apr. 16, 2014

(51) Int. Cl. H05B 41/285; H05B 41/282

(52) U.S. Cl. CPC H05B 41/2856; H05B 41/2824

(57) ABSTRACT

Provided is a method to detect an arcing condition in an arc discharge lamp ballasts is disclosed. An AC current signal flows from the lamp load to ground via at least one ring core. The ring core is provided for detecting an arcing condition in AC current signal and the ballast circuit by detecting a current spike along the ring core. When there is a current spike in the primary core, created by the arcing condition, a proportional increase in voltage within a control signal occurs on the secondary core. A rectifier circuit is used for conditioning the increase in voltage within the control signal. A control circuit, responsive to the increase in voltage within the control signal, dynamically adjusts the operating frequency of a resonant inverter so that the arcing condition is extinguished.

### FIELD OF THE INVENTION

The present invention relates generally to lighting ballasts. More particularly, the present invention relates to detecting arcing condition within a ballast current loop.

### BACKGROUND OF THE INVENTION

Arcing is the electrical breakdown of a gas that produces an ongoing discharge resulting from a current flowing through a normally non-conductive media, such as air. In lamp systems, arcing often occurs when there is a small air gap between the terminals that electrically connect a lamp to an electronic ballast. For example, a small air gap is often created between ballast connector terminals and lamp pins when the lamp is removed from the ballast.

The occurrence of arcing in lamp systems can seriously damage the ballast and the lamp, as well as pose a hazard to safety. Arcing, particularly when prolonged, can result in a deposition of carbon at he ballast connector terminals, which can cause flashover of the ballast connector terminals and the lamp pins. These conditions can cause the ballast to malfunction or start a fire.

Unfortunately, arcing in ballasts can be difficult to detect. Conventional methods often detect arcing conditions at the lamp load, making it difficult to prevent or extinguish the arcing condition without recycling the power to the load.

### SUMMARY OF EMBODIMENTS OF THE INVENTION

Given the aforementioned deficiencies, a need exists for a more reliable ballast system. that is capable of detecting arcing conditions within the current loop such that arcing conditions can be eliminated or reduced before reaching the load. More specifically, a need exists for systems and techniques for detecting arcing in current loops to prevent or extinguish the arcing condition without having to recycle the power to the load.

In an exemplary embodiment, a method to detect an arcing condition in an arc discharge lamp ballasts is disclosed. An alternating current (AC) signal flows through a current loop and is used to drive a lamp load. The AC signal flows from the lamp load to ground via at least one ring core. The ring core is provided for detecting an arcing condition in AC signal and the ballast circuit by detecting a current spike along the ring core.

When a current spike is present in the primary core, created by the arcing condition; a proportional increase in voltage within a control signal occurs on the secondary core. A rectifier circuit is used for conditioning the increase in voltage within the control signal. A control circuit, responsive to the increase in voltage within the control signal, dynamically adjusts the operating frequency of a resonant inverter so that the arcing condition is extinguished.

In an embodiment, the magnitude of the control signal during normal operation is zero. In a further embodiment, the control signal can be used to control the inverter operating frequency, so that the high frequency bus voltage can be driven lower to eliminate arcing. The arcing conditions can be detected through the ground line when arcing happens by inserting a ring core or any other type of transformers into the ground line. The arcing conditions can also be detected through the Y cap of the electro-magnetic interference (EMI) filter. The detection circuit uses a rectifier circuit to rectify the detected arcing signal detected via the ring core or transformers to the control signal. When arcing occurs, the magnitude of the control signal increases, which causes the control circuit to regulate the frequency of the inverter. When the ballast operating frequency increases, the high frequency bus voltage is driven lower so that the arcing condition is eliminated.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of an exemplary lighting system with an arc detection circuit, according to an exemplary embodiment;

FIG. 2 is a schematic diagram of an exemplary an arc detection circuit in connection with a ballast circuit, according to an exemplary embodiment;

FIG. 3 is a schematic diagram of an exemplary an arc detection circuit in connection with a ballast circuit and a control circuit, according to an exemplary embodiment; and

FIG. 4A is a graphical illustration of an arcing current according to an exemplary embodiment;

FIG. 4B is a graphical illustration of an exemplary control signal used in accordance with an exemplary embodiment.

### DETAILED DESCRIPTION OF EMBODIMENTS OF THE INVENTION

While the present invention is described herein with illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

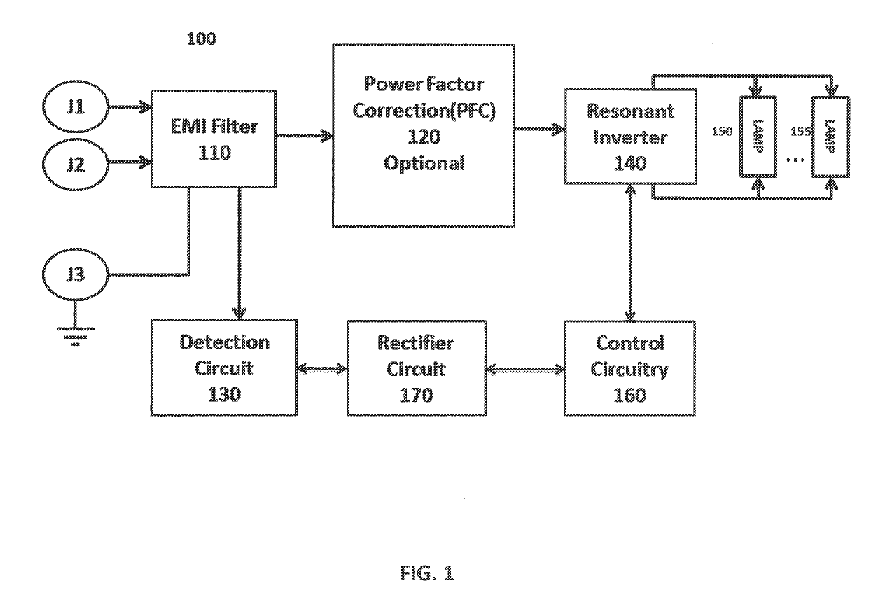

FIG. 1 is a block diagram illustration of an exemplary ballast arc elimination circuit 100 having an arc detection circuit 130 in which embodiments of the present invention may be practiced. The EMI filter 110 is used to reduce noise in the circuit. An optional power correction factor circuit 120 is provided to improve voltage regulation at the load. Next a resonant inverter 140 is provided to change transform direct current into alternating current in order to power the lamp loads 150-155. A control circuit 160 is provided to drive the lamp loads 150-155. Next a rectifier circuit 170 is provided to rectify a direct current (DC) voltage within the control signal. The detection circuit 130 is provided to detect and arching condition in the circuit. By way of background, electronic ballasts are widely used to drive fluorescent lamps. These electronic ballasts are necessary to prevent the current through the fluorescent lamp tube from rising to destructive levels due to negative resistance characteristics. Disclosed herein are methods to detect an arcing signal within the electronic ballast circuitry when arcing conditions occur for arc discharge lamp ballasts.

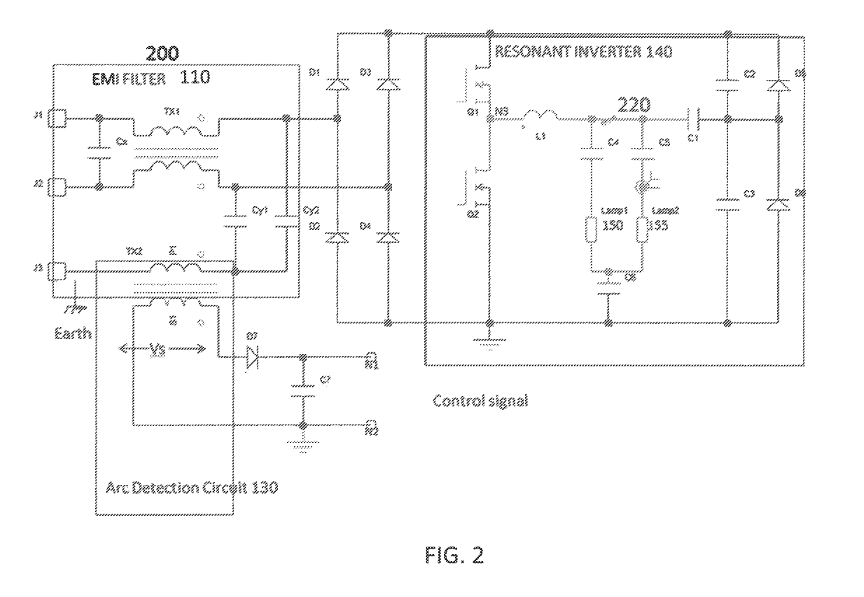

FIG. 2 is a schematic diagram of an exemplary electronic ballast circuitry. The diagram illustrates an arc detection circuit 130 configured for operating within the ballast arc elimination circuit 200 of FIG. 2, according to the embodiment of the present invention. As such, some reference characters depicted in FIG. 1 are reused in the description of FIG. 2.

Further in FIGS. 1 and 2, a first alternating current (AC) loop includes a power input terminal J1, one EMI filter 110, an optional power factor correction circuit 120, a resonant inverter 140, lamp load 150, control circuit 160, rectifier circuit 170, an arc detection circuit 130, and ground terminal J3. A second AC current loop includes a power input terminal J2, one EMI filter 110, an optional power factor correction circuit 120, a resonant inverter 140, lamp load 155, control circuit 160, rectifier circuit 170, an arc detection circuit 130, and ground terminal J3. Although the diagram illustrates two AC current loop systems, J1-J3 and J2-J3, any number of current loops systems and lamp loads could be used in this method.

Turning now to FIG. 2, the first current loop includes input terminal J1, one EMI filter TX1, the rectifier bridge diode D1, resonant inductor L1, output capacitor C4 or C5, lamp load 150 or 155, DC blocking capacitor C6, rectifier diode D4, the capacitor Cy1 and ground terminal J3.

The second AC current loop includes an input terminal J2, one EMI filter TX1, the rectifier bridge diode D3, resonant inductor L1, output capacitor C4 or C5, lamp load 150 or 155, DC blocking capacitor C6, rectifier diode D4, the capacitor Cy2 and ground terminal J3.

The resonant inverter 140 as described in more detail below generates a high frequency bus 220. First and second lamp loads 150, 155, are coupled to the high frequency bus 220 via first and second, ballasting capacitors C4, C5. Thus, if one lamp is removed, the others continue to operate. It is contemplated that any number of lamps (and corresponding ballasting capacitors) can be connected to the high frequency bus 220. Therefore, for each lamp load 150, 155, . . . Nth can be coupled to the high frequency bus 220 via an associated ballasting capacitor C4, C5, . . . CN. Power to each lamp load 150, 155, . . . Nth is supplied via connection to capacitor C6 and ground.

The Resonant Inverter 140 includes analogous upper and lower or first and second switches Q1 and Q2, for example, two n-channel metal oxide semiconductor field effect transistor (MOSFET) devices (as shown), serially connected between inputs J1 or J2 and ground, to excite the inverter 140. Two P-channel MOSFETs may also be configured. The high frequency bus 220 is generated across the resonant inverter 140 and includes a resonant inductor L1 and an equivalent resonant capacitance which includes the equivalence of first, second and third capacitors C1, C2, C3, and ballasting capacitors C4, C5, . . . CN, which also prevent DC current from flowing through the lamp loads 150, 155, . . . Nth. The ballasting capacitors C4, C5, . . . CN are primarily used as ballasting capacitors.

The switches Q1 and Q2 cooperate to provide a square wave at a common or first node N3 to excite the resonant inverter 140 across the high frequency bus 220. A control signal in connection with the switches Qi and Q2 are connected at control nodes N1 and N2.

Further in FIG. 2, an input AC current enters the exemplary lighting ballast system circuit 100 at J1 and J2, wherein the input AC current is filtered through the EMI Filter 110. Common-mode noise (CMN) is suppressed by using dual-wound ring core TX1. These inductors are wound in such a way that they present high impedance to the in-phase common-mode noise at each AC current input J1, J2. In addition, the Y-capacitors Cy1 and Cy2 shunt or bypass the high-frequency common mode noise to ground. Differential-mode noise (DMN) on each AC conductor J1, J2 is suppressed by the x-capacitor Cx. The x-capacitor Cx tends to neutralize the out-of-phase high-frequency DMN that exists between the AC power line and neutral conductors.

The detection circuit 130 is configured such that as the input AC current flows through the ring core TX2, the input AC current spikes on the primary side P1 of the ring core during an arcing condition. This allows the acing condition to be detected as the input AC current flows through the first current loop J1-J3 or the second current loop J2-J3. This input AC current spike results in a corresponding DC voltage spike across the control signal on the secondary side S1 of the ring core as explained below. When the DC voltage across the control signal exceeds a preset threshold, indicating the presence of an arcing condition, the rectifier circuit 170 rectifies the control signal such that the arching condition can be extinguished by the control circuitry 160. The control circuit 160 is able to extinguish the arcing condition by generating a command signal to control the supply of the ballast output power to the lamp loads 150, 155 during the arc condition.

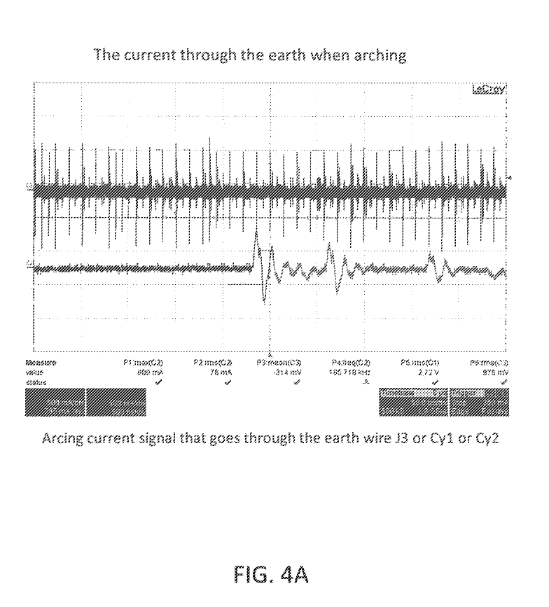

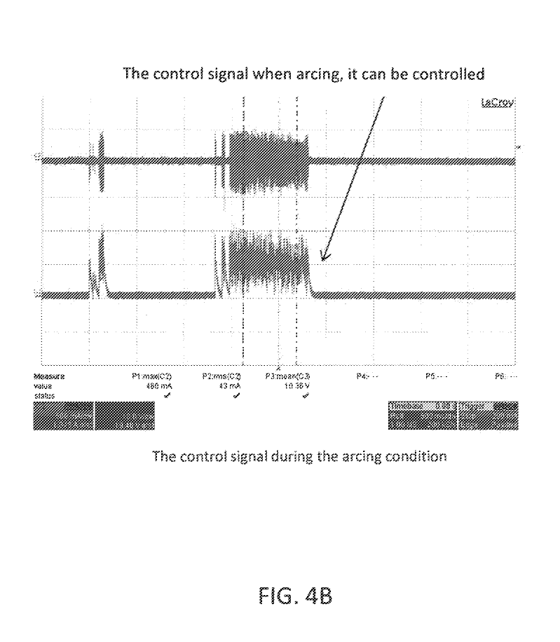

The detection circuit 130 can sense an arcing signal at Cy1 and Cy2 or J3 or at any point along the current loops. However, the arcing signal (the current spike as shown in FIG. 4A) can be detected at various points along the current loops. Therefore, the detection circuit 130 senses a current spike from these points without the need to handle the power signal (AC current). This allows, the detection circuit 130 can be constructed at lower cost.

The ballast arc elimination circuit 200 is able to sense an arcing signal at Cy1 and Cy2, or J3 by employing a ring core TX2 (or transformer). The ring core TX2 is inserted between the ground line J3 and capacitors Cy1 and Cy2. The arc detection circuit 130 works in conjunction with the rectifier circuit 170 to rectifier the arcing DC voltage across the DC control signal. A DC control signal flows through the secondary coil S1 of ring core TX2 for regulating the lamp load 155. The DC control signal typically maintains a steady voltage, for example 10 volts.

When an arcing condition occurs, there is a current spike within the input AC current flowing through the primary side P1 of the ring core TX2. Based on the turn ratio of the ring core, a proportional current spike will also flow through the secondary side S1 of the ring core, which is connected to the rectifier circuitry 170 and the control circuitry 160. This proportional current spike will cause a proportional DC voltage spike within the control signal on the secondary side of the ring core S1. The control signal containing the DC voltage spike is rectified within the rectifier circuitry.

In an exemplary embodiment, the rectifier circuitry 170 is comprised of capacitors D7 and C7. When arcing occurs, the magnitude of the DC voltage across the control signal will increase. Since this control signal is also connected to the control circuit 160, there is some certain steady-state value, for example, 10 V, which the control signal normally maintains. When the magnitude of the DC voltage across the control signal increases to a value greater than the exemplary steady-state, for example, 20 V; the control circuit will regulate the frequency of the resonant inverter in order to eliminate the arching condition.

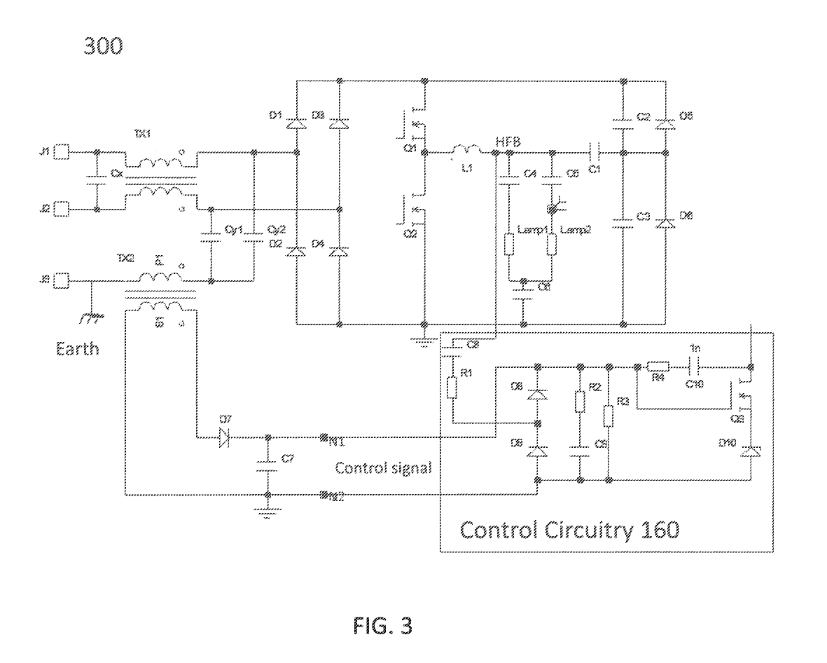

Further in FIGS. 2 and 3, the control circuit 160 can be used to eliminate the arching condition by regulating the high frequency bus (HFB) voltage across the load 150-155. The HFB voltage is regulated as the control signal drives the voltage-fed resonant inverter 140. The resonant inverter 140 works in the inductive mode such that the HFB voltage has a one-to-one inverse relationship with the inverter operating frequency.

When an arcing condition occurs, an arcing input AC current spike flows through the primary coil P1 of the ring core transformer TX2, resulting in a DC voltage Vs spike flowing through the secondary core S1. This increased instantaneous DC voltage spike Vs, causes the control signal to then regulate the inverter frequency to a higher level, for example, from an exemplary 70 kHz to an exemplary 90 kHz. When the inverter frequency is driven higher, this results in a lower voltage across the HFB and load, which will extinguish the arcing condition. This process can also eliminate the need to recycle the input AC current as the arcing condition is extinguished. This is in contrast to pervious techniques that required the shut down of the inverter.

When the arcing condition is extinguished, there is no current spike flowing through ring core TX2, and the control signal then goes back to its steady state voltage, in this example, 10 V. The inverter frequency also goes back to normal condition, which is about 70 KHz, so the ballast works normally again, without the need to recycle the input AC current.

FIG. 3 is a more detailed schematic diagram of an exemplary control circuit 160 as is disclosed in U.S. Pat. No. 7,436,124B2 and configured for operating within the ballast circuit 100, according to an embodiment. FIG. 3 depicts an exemplary embodiment 300 of how the control circuitry 160 is connected to the arc detection circuitry 130 and inverter 140. Methods of driving the inverter circuitry using a control signal are known in the art. For example, the control circuitry 160 controls the operating frequency of the inverter 140 to regulate the HFB voltage.

FIG. 4 is a graphical illustration of an arcing signal. In FIG. 4A, the arcing current spike signal C2 is originally detected at Cy1, or Cy2, or Cy1 and Cy2, or ground, prior to being rectified and filtered. Signal Z2 represents the zoom area of one current spike in C2.

Similarly, FIG. 4B is a gaphical illustration of the control signal during an arcing condition. In this example, C2 represents the arcing current spike in the same manner as FIG. 4A, wherein C3 represents the rectified current signal, which is used as the control signal.

### CONCLUSION

The present invention has been described above with the aid of functional building layers illustrating the implementation of specified functions and relationships thereof. The boundaries of these functional layers have been arbitrarily defined herein for the convenience of the description. Alternate boundaries can be defined so long as the specified functions and relationships thereof are appropriately performed.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

What is claimed is:

1. An apparatus for detecting an arcing condition in an electronic ballast circuit, the arcing condition producing a current spike, the apparatus comprising:
an inverter for driving a lamp load;
wherein the current spike flows from the lamp load to ground via at least one ring core when the arcing condition;
wherein the current spike flows through a primary side of the ring core producing a corresponding increase in voltage within a control signal on a secondary side of the core;
a rectifier circuit for conditioning the increase in voltage; and
a control circuit responsive to the increase in voltage for adjusting an operating frequency of the inverter for extinguishing the arcing condition.

2. The apparatus of claim 1, wherein the at least one ring core is a transformer.

3. The apparatus of claim 2, wherein the transformer acts as a detection circuit for detecting an arching condition within the current loop of a ballast lamp load circuit when the magnitude of a voltage within the control signal exceeds a threshold.

4. The apparatus of claim 1, wherein the proportional increase in voltage from the secondary ring core is rectified to the control signal.

5. The apparatus of claim 4, wherein when the arcing condition creates a voltage spike exceeding a threshold, the rectified control signal reaches a set point, such that the control signal will thereby increase the operating frequency of the resonant inverter.

6. The apparatus of claim 1, wherein the arcing condition can be detected anywhere along a Y capacitor between line or a neutral wire and ground of the electronic ballast circuit.

7. The apparatus of claim 1, wherein the arcing condition can be detected anywhere along the ground wire of the electronic ballast circuit.

8. An electronic ballast circuit, comprising:
an inverter for driving a lamp load;
wherein a current spike is produced when arcing occurs within the circuit, the current spike flowing from the lamp load to ground via at least one ring core;
wherein the current spike flows through a primary side of the ring core producing a corresponding voltage increase within a control signal on a secondary side of the core;
a rectifier circuit for conditioning the voltage increase; and
a control circuit, responsive to the voltage increase, configured to dynamically adjust the operating frequency of the inverter for extinguishing the arcing condition.

9. The electronic ballast circuit of claim 8, wherein the at least one ring core is a transformer.

10. The electronic ballast circuit of claim 9, wherein the transformer acts as a detection circuit for detecting an arching condition within the current loop of a ballast circuit when the magnitude of a voltage within the control signal exceeds a threshold.

11. The electronic ballast circuit of claim 9, wherein the proportional increase in voltage from the secondary ring core is rectified to the control signal.

12. The electronic ballast circuit of claim 11, wherein when the arcing condition creates a voltage spike that exceeds a threshold, the rectified control signal reaches a set point, such that the control signal will thereby increase the operating frequency of the resonant inverter.

13. The electronic ballast circuit of claim 8, wherein the arcing condition can be detected anywhere along a Y capacitor between line or a neutral wire and ground of the circuit.

14. The electronic ballast circuit of claim 8, wherein the arcing condition can be detected anywhere along the ground wire of the electronic ballast circuit.

15. An electronic ballast circuit, comprising:
an inverter for driving a lamp load;
wherein a current spike is produced when arcing occurs within the circuit, the current spike flowing from the lamp load to ground via at least one ring core;
wherein the current spike flows through a primary side of the ring core producing a corresponding voltage increase within a control signal on a secondary side of the core;
a rectifier circuit for conditioning the voltage increase; and
a control circuit, responsive to the voltage increase for dynamically adjusts the operating frequency of the inverter to extinguish arcing condition.

16. The ballast circuit of claim 15, wherein the at least one ring core is a transformer.

17. The ballast circuit of claim 16, wherein the transformer acts as a detection circuit for detecting an arching condition within the current loop of a ballast circuit when the magnitude of a voltage within the control signal exceeds a threshold.

18. The ballast circuit of claim 17, wherein the proportional increase in voltage from the secondary ring core is rectified to the control signal.

19. The ballast circuit of claim 18, wherein when the arcing condition creates a current spike that exceeds a threshold, the rectified control signal reaches a set point, such that the control signal will thereby increase the operating frequency of the resonant inverter.
